(19) United States
(12) Patent Application Publication
(10) Pub. No.: US 2025/0342156 A1
(43) Pub. Date: Nov. 6, 2025

(54) DISTINCT PLAN CAPTURE FOR QUERY PLAN STABILITY

(71) Applicant: SAP SE, Walldorf (DE)

(72) Inventors: Sungwon Kim, Seoul (KR); Heesik Shin, Seoul (KR); Sanghee Lee, Seoul (KR)

(73) Assignee: SAP SE, Walldorf (DE)

(21) Appl. No.: 18/653,355

(22) Filed: May 2, 2024

(51) Int. Cl. G06F 16/2453

(52) U.S. Cl. CPC G06F 16/24542; G06F 16/24537

(57) ABSTRACT

A computer implemented method can generate a current query execution plan for a query and serialize the current query execution plan into a current query plan object. The current query plan object specifies a query tree which defines a plurality of query operators of the current query execution plan. The method can compare the current query plan object with one or more stored query plan objects contained in a plan repository. The one or more stored query plan objects were serialized from previous query execution plans generated for the query. Responsive to finding that no stored query plan object matches the current query plan object, the method can store the current query plan object in the plan repository. Related systems and software for implementing the method are also disclosed.

### BACKGROUND

A query plan (also referred to as “query execution plan”) is a sequence of steps that a database management system (DBMS) executes in order to complete a structured query language (SQL) query. When a query is run for the first time in the DBMS, the query can be compiled by a query optimizer to generate a corresponding query plan, which can be stored in memory called “query plan cache,” or simply “plan cache.” Thus, when the same query is run again, the DBMS does not need to regenerate the query plan. Instead, it can reuse the cached query plan stored in the plan cache, thereby improving efficiency of the DBMS.

Even for the same query, the query plan generated by the query optimizer can change over time, e.g., due to system upgrade to the database or other reasons. While a system upgrade often leads to performance improvement of query plans, performance regression of query plans can occur in certain circumstances. To mitigate potential performance regression of query plans, the query optimizer may attempt to reuse previously captured query plans that have good or acceptable performance. This feature is known as query plan stability (QPS). However, a challenge associated with maintaining these captured plans is that they require storage space, which necessitates careful management to prevent overflow of the allocated storage capacity. Thus, there remains a need for improved technologies in managing the storage of captured query plans to optimize resource utilization and maintain system performance.

### BRIEF DESCRIPTION OF THE DRAWINGS

FIG. 1 is an overall block diagram of an example database management system supporting QPS.

FIG. 2 is a block diagram depicting example transformations for a query plan.

FIG. 3 is a block diagram depicting example components of a QPS manager.

FIG. 4 is a flowchart illustrating an example overall method of implementing distinct query plan capture for query plan stability.

FIG. 5 depicts an example query tree representing a query plan generated for a query.

FIG. 6 depicts two example pseudo-code algorithms that can be used to traverse a query tree.

FIG. 7 depicts a portion of an example query plan object including a list of operators defined by the query tree of FIG. 5.

FIG. 8 depicts another portion of the example query plan object of FIG. 7 including a list of expressions defined by the query tree of FIG. 5.

FIG. 9 depicts another portion of the example query plan object of FIG. 7 including a list of data sources defined by the query tree of FIG. 5.

FIG. 10 depicts another portion of the example query plan object of FIG. 7 including a list of annotations defined by the query tree of FIG. 5.

FIG. 11 depicts an example pseudo-code algorithm that can be bused to parse a query plan object to generate a tree-shape string.

FIG. 12 depicts an example tree-shape string generated based on the query plan object of FIGS. 7-10 and a corresponding hash value.

FIG. 13 is a block diagram of an example computing system in which described embodiments can be implemented.

FIG. 14 is a block diagram of an example cloud computing environment that can be used in conjunction with the technologies described herein.

### DETAILED DESCRIPTION

### Overview of Query Plan Stability

The aim of query optimization, by a query optimizer, is to select a query plan (from many candidate query plans) that yields optimal performance. Performance of a query plan can be described in terms of cost, which can be time (e.g., time required to execute the query plan) and/or burden on computing resources (e.g., processing power and/or memory expended to execute the query plan). Cost-based query optimization chooses the query plan with the lowest cost among all candidate query plans. In practice, although the terms “optimal” and “optimize” are used, the actual best plan may not be selected, but the selected plan is deemed better than others based on data available to the query optimizer.

The stability of a single query's performance can be quite volatile due to its heavy reliance on the decisions made by the query optimizer. These decisions are often based on uncertainty, and in many cases, they reflect changes in the base data, generating execution plans that are equivalent or superior in terms of performance. However, there are instances where performance regressions occur, meaning the altered query plans perform worse than their predecessors.

In a DBMS, performance regression can occur for a variety of reasons. One major cause of performance regressions is changes in the system's coding. For example, when a system undergoes an upgrade, the query plans for various queries may change due to alterations in the code related to the underlying query optimization algorithm, such as logical equivalent plan enumeration rules, physical algorithm enumeration rules, and/or size estimation and cost calculation. While normally these changes can result in improved performance, there are instances where they lead to regressions.

Another factor contributing to performance regression is skew in data distribution. For instance, if the values in a column of a database table are skewed, the query optimizer's size estimation often fails to predict a reasonable result size for an operation. This inaccurate size estimation can lead the query optimizer to generate a sub-optimal query plan for a query, resulting in a performance regression.

Changes in data distribution can also lead to performance regressions. For example, if a table's record count changes significantly, a previously compiled and cached plan on the table can be automatically recompiled to generate a plan that better reflects the recent data distribution. However, a performance regression may occur if the newly compiled plan is slower than the previously compiled one.

Record sampling for size estimation can also cause performance regressions. In certain cases, histograms can be used to represent the distribution of values in a column of a table. However, in the absence of a histogram, sampling can be used to estimate filter selectivity or join selectivity. This means that different values can be used whenever size estimation is performed, potentially leading to changes in the resulting plan. These changes can cause performance regression.

Further, the process of compiling queries with specific parameter values can sometimes lead to performance regressions. In certain scenarios, the query optimizer supports what is known as “parameter-aware” query optimization (where the query optimizer knows the value assigned to a query parameter). However, there are limitations when it comes to binding parameter values used for this type of optimization. These parameter values directly influence the filter selectivity, leading to a query plan that is optimized for the bound values. Nevertheless, for different parameter values, the query plan may be suboptimal. This variability in the performance of the query plan, based on parameter values, represents another potential source of performance regression.

To mitigate potential performance regression of query plans, the QPS feature can be implemented in the DBMS, such as the SQL Plan Stability implemented in SAP HANA, provided by SAP SE of Walldorf, Germany. The QPS feature offers the option to preserve a query's execution plan by capturing a logical representation of the query plan, also referred to as an abstract SQL plan (“ASP”), which can also be referred to as a “query plan object” or an “ASP object” hereinafter. When performance regression is detected for the query, the previously captured ASP can be used to regenerate the original query plan so as to retain the original performance.

However, maintaining captured ASPs for different queries require substantial storage space, especially when dealing with a large number of complex queries. The technology described herein provides an improved QPS management solution to address these challenges. Specifically, it introduces an intelligent ASP retention strategy that effectively avoids the storage of duplicated ASPs. This strategy ensures that only ASPs representing distinct query plans are captured and stored, thereby optimizing storage usage and improving overall system efficiency.

### Example Computing System with Improved Query Plan Stability Management

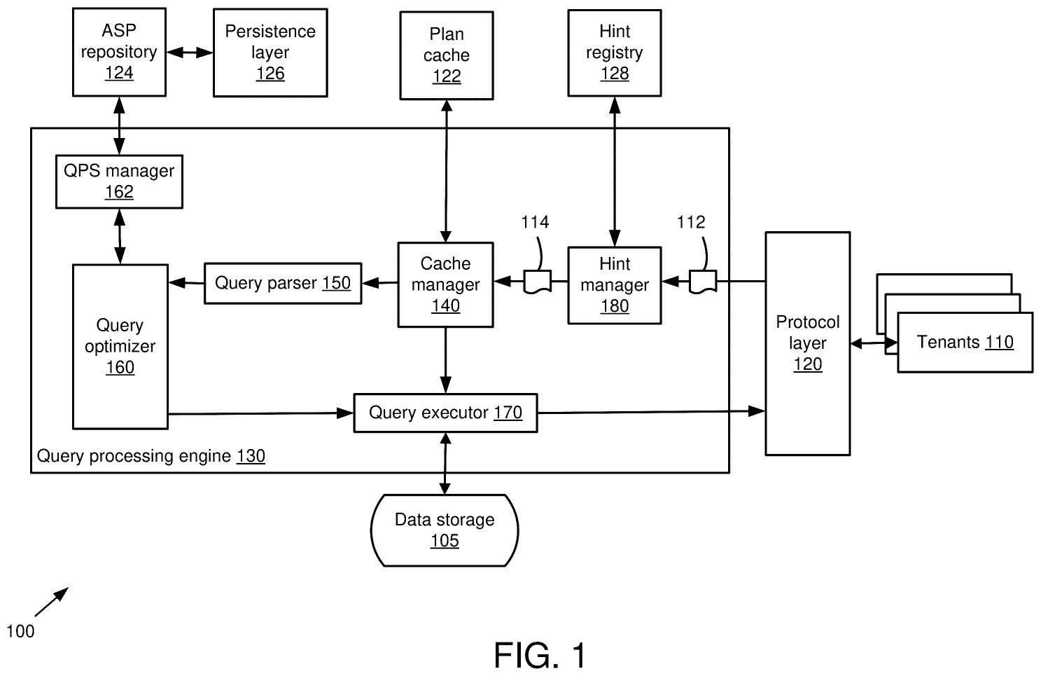

FIG. 1 shows an overall block diagram of an example database management system 100 improved QPS management. The database management system 100 can be configured to support multi-tenancy, which is a feature in many types of cloud computing services. In a multi-tenancy environment, one instance of a software application and supporting infrastructure (e.g., virtual machines, memories, etc.) can serve multiple user groups, or tenants. Thus, multiple tenants can share the same application and other computing resources running on the same operating system, on the same hardware, with the same data-storage mechanism(s). Even though resources are shared, each tenant can appear to have its own instance of the application. Importantly, the underlying data of the tenants can be kept separate and secure.

As shown, the database management system 100 includes a query processing engine 130 and a protocol layer 120 which serves as an interface between one or more tenants 110 and the query processing engine 130. For example, the protocol layer 120 can implement a server name indication protocol by which the tenants 110 can connect to the query processing engine 130. Each tenant 110 represents a group of users who can access a tenant-specific database (e.g., data storage 105) managed by the database management system 100.

In some examples, the query processing engine 130 can include a hint manager 180, a cache manager 140, a query parser 150, a query optimizer 160, a query executor 170, and a QPS manager 162.

An incoming query 112 sent from a tenant 110 can be processed by the hint manager 180 to output a query 114, which can be the same as or different from the incoming query 112. The hint manager 180 maintains a hint registry 128. The hint registry 128 can store hint records, each of which includes a hint target and a hint (also referred to as a “hint string”) paired with the hint target. In some examples, a hint target can be a query statement, which can also be referred to as a “target query statement.” In this scenario, the hint in the hint record is paired with the target query statement. In some examples, a hint target can be one or more database objects, which can also be referred to as “target objects.” In this scenario, the hint in the hint record is paired with the one or more target objects.

The hint manager 180 can search the hint registry 128 to identify if the incoming query 112 has a matching hint record. If a match is found, the hint specified in the hint record can be added to the incoming query 112, modifying it into a new query. This modified query is then propagated downstream for further processing. If no matching hint record is found, the incoming query 112 is not modified and is passed directly for downstream query processing.

For hint records containing hint targets that are target query statements, the hint manager 180 can use string comparison to determine if the incoming query 112 matches any of the target query statements. The target query statements can be patterned or non-patterned. As described herein, a patterned query statement includes a wildcard expression, whereas a non-patterned query statement is absent of a wildcard. A wildcard expression can be a special character or sequence of characters that matches any character or set of characters in a string. This wildcard can take various forms, including matching any literals, matching literals within a set of constants, matching literals within a range, or matching literals that start with a specific string or are of a specific datatype.

For hint records containing hint targets that are target objects, the hint manager 180 can parse the incoming query 112 to determine if the target objects appear in the incoming query 112. For example, a hint paired to a target object can be appended to any incoming queries in which the target object is specified. As described herein, the target objects can include database tables, database views, table functions, synonyms, sequences, etc.

The cache manager 140 can access a plan cache 122, which represents a fast-access memory space configured to store previously compiled query plans. The cache manager 140 receives the query 114 (which can be the incoming query 112 added with a hint or the unmodified incoming query 112) sent from the hint manager 180. The cache manager 140 can evaluate the received query 114 to determine if the query 114 has a corresponding (compiled) query plan stored in the plan cache 122.

If the cache manager 140 finds no query plan in the plan cache 122 that corresponds to the query 114, the query 114 can be analyzed by the query parser 150, which can check if the query 114 contains syntactic and/or semantic errors. After verifying that the query 114 is a valid transactional SQL statement (e.g., SELECT, INSERT, UPDATE, DELETE, MERGE, etc.), the query parser 150 can generate a logical tree (also referred to as a “query tree”) in which the query 114 can be executed.

As described herein, a query tree is a logical representation of the query statement. It includes a plurality of nodes and edges linking the nodes. The nodes can include leaf nodes and one or more internal nodes. A leaf node has no child nodes. In contrast, an internal node has one or more child nodes. The root of the query tree, or root node, can be regarded as a special internal node. The query tree denotes a relational algebra expression. Specifically, tables involved in the query can be represented as leaf nodes. The relational algebra operations can be represented as internal nodes. The root node represents the query as a whole and can also be referred to as a “project” node. When a query plan is executed, an internal node can be executed when its operand tables are available. The internal node can then be replaced by a result table generated by the operation represented by the internal node. This process can continue for all internal nodes until the root node is executed and replaced by the result table, which can be returned as query results.

The logical tree can be used by the query optimizer 160 to generate a corresponding query plan, which determines how the query 114 will be executed. The query optimizer 160 is configured to select a query plan (among a plurality of query plans that are generated based on enumeration of the logical tree) that yields optimal performance. Performance of a query plan can be described in terms of cost, which can be time (e.g., time required to execute the query plan) and/or burden on computing resources (e.g., processing power and/or memory expended to execute the query plan). Cost-based query optimization chooses the query plan with the lowest cost among all candidate query plans. In practice, although the terms “optimal” and “optimize” are used, the actual best query plan may not be selected, but the selected query plan is deemed better than others based on data available to the query optimizer 160.

The determined optimal query plan can then be sent to the query executor 170 for execution. The query executor 170 can communicate with a data storage 105 and execute operators in the query plan determined by the query optimizer 160. Data retrieved from the data storage 105 can be returned to the tenant 110 via the protocol layer 120.

As described herein, query compilation refers to the process of converting the query 114 to the optimal query plan (e.g., checking syntactic and/or semantic errors, generating the logical tree, and determining optimal query plan), as described above. Depending on the complexity of the query 114 (e.g., the number of joined tables, etc.) and the query optimization algorithm, query compilation time can be long (e.g., tens of seconds or more). Thus, to improve operational efficiency, the compiled query plan (i.e., the determined most optimal query plan) for the query 114 can be stored in the plan cache 122 so that it can be quickly retrieved and reused if the same query is encountered again in the future.

For example, if the cache manager 140 determines that the query 114 has a corresponding query plan stored in the plan cache 122, that query plan can be fetched directly from the plan cache 122 and forwarded to the query executor 170 for execution. Thus, in this scenario, operations by the query parser 150 and query optimizer 160 can be bypassed. In other words, the query 114 does not need to be recompiled because its previously compiled query plan is available in the plan cache 122.

The plan cache 122 is configured to store compiled query plans. For each received query 114, the cache manager 140 checks if it has a compiled query plan stored in the plan cache 122. If yes, then this cached query plan can be reused. This can improve efficiency because it eliminates the time of compiling the query 114 (i.e., regenerating the query plan). On the other hand, if the query 114 has no compiled query plan stored in the plan cache 122, the query 114 has to be compiled. The compiled query plan can then be stored in the plan cache 122 so that when the same query 114 occurs again in the future, fast access to its cached query plan is feasible.

If the received query 114 is new (i.e., a first-time query that has not been encountered before), this new query has no corresponding query plan in the plan cache 122 and it must be compiled for the first time. On the other hand, if the received query 114 is old (i.e., the same query has been encountered at least once before), whether or not there is a corresponding compiled query plan in the plan cache 122 can depend on the size of the plan cache 122 and a plan eviction policy adopted by the cache manager 140.

The plan cache 122 has a limited size. Thus, it may not be able to store all compiled query plans. When the plan cache 122 approaches its full capacity, certain query plans may have to be evicted from the plan cache 122 to make room for new ones according to a predefined plan eviction policy implemented by the cache manager 140. For example, the cache manager 140 can implement a random plan eviction policy which evicts query plans from the plan cache 122 in a random manner. In another example, the cache manager 140 can implement the least recently used (LRU) plan eviction policy which removes the least recently used query plans first from the plan cache 122. In yet another example, the least frequently used (LFU) plan eviction policy can be used which first evicts the execution policies that are used least often. Other plan eviction policies can also be used by the cache manager 140.

As described above, performance regression of query plans can occur, e.g., due to a system upgrade and/or data change of the database management system 100. To mitigate potential performance regression of query plans, the query plan optimizer 160 can interact with a QPS manager 162, which is configured to capture query plans generated by the query optimizer 160 and serializing the captured query plans into corresponding ASPs. The QPS manager 162 can communicate with an ASP repository 124, which stores a collection of serialized ASPs, along their corresponding execution statistics (e.g., the execution time, the CPU consumption, the peak memory usage, etc.).

The QPS manager 162 can utilize the ASP repository 124 to implement the QPS feature by capturing selected query plans into ASPs and storing them in the ASP repository 124. In the event of performance regression for a query plan, these stored ASPs can be reused to recreate the original query plans, thereby preserving the original performance. Moreover, as described further below, the ASP repository 124 can be configured to store a plurality of ASPs representing distinct query plans for each query. In other words, different queries can have separate ASP storages within the ASP repository 124, and the stored ASPs for each query represent unique query plans, ensuring no duplication.

In some examples, the ASP repository 124 can be allocated in a volatile memory, which allows for fast access and manipulation of the data. In some examples, data stored in the ASP repository 124 can be persisted to a persistence layer 126. The persistence layer 126 can ensure that the ASPs and execution statistics are retained even when the volatile memory is cleared during a system restart. This allows for the data to be reloaded from the persistence layer 126 back into the ASP repository 124 in the memory, e.g., after the system restart, ensuring the continuity of QPS.

In practice, the systems shown herein, such as database management system 100, can vary in complexity, with additional functionality, more complex components, and the like. For example, there can be additional functionality within the query processing engine 130. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The database management system 100 and any of the other systems described herein can be implemented in conjunction with any of the hardware components described herein, such as the computing systems described below (e.g., processing units, memory, and the like). In any of the examples herein, the queries, query plans, hints, ASPs, and the like can be stored in one or more computer-readable storage media or computer-readable storage devices. The technologies described herein can be generic to the specifics of operating systems or hardware and can be applied in any variety of environments to take advantage of the described features.

### Example Overview of Distinct Query Plan Capture

As described above, the QPS feature can mitigate potential performance regressions of query plans. It achieves this by capturing query plans generated by a query optimizer, serializing these captured query plans into ASPs, and subsequently storing these ASPs in a dedicated storage, such as the ASP repository 124. To enable the QPS feature across all queries, each query needs to have a corresponding list of ASPs stored within the ASP storage. However, the requirement to maintain distinct lists of ASPs for different queries can demand substantial storage space, particularly when dealing with a large number of complex queries. Thus, the maximum number of ASPs stored for each query needs to be limited. For example, the ASP repository 124 can be configured to accommodate up to M ASPs for each individual query, where M is a predefined integer that defines the storage capacity (e.g., M=30, 50, 80, etc.). As another example, the ASP repository 124 can allocate storage space with a predefined size (e.g., 5 MB, 10 MB, etc.) for each query. This capacity constraint necessitates efficient management of the ASP storage. Efficient management includes avoiding the storage of duplicate ASPs, which can consume limited storage space and block new, potentially more efficient ASPs from being stored. Therefore, implementing a mechanism to detect and prevent the storage of duplicate ASPs can significantly enhance the efficiency of the ASP storage management and the overall performance of the QPS feature.

Improved QPS management can be achieved by capturing and storing only distinct query plans. A query plan is a sequence of query operations used to access data in a SQL relational DBMS. In this context, two query plans are deemed to be identical if they involve the same sequence of query operators and access the same data objects (e.g., tables, views, etc.), meaning they have the same logical relationship of query operations and they execute these operations in the exact same order on the same data source.

As described above, a query plan can be represented by a query tree including nodes and edges connecting the nodes. Each node can represent a query operation (e.g., an internal node can represent a relational algebra operation, and a leaf node can represent an operation for data access to a data object), and the edges depict the logical flow of data between these query operations. In this tree representation, the topological structure or the “shape” of the tree defines the logical relationship of query operations. Thus, two query plans are considered identical if their corresponding query trees have the same tree shape. This means that they have the same arrangement and sequence of query operations (including access to data sources).

Direct comparison of query plans or ASPs can be challenging and often not meaningful. This is because the query plans or ASPs may include a lot of auxiliary details, such as metadata, comments, formatting instructions, etc., that do not affect the shape of the query trees (thus the logical relationship of query operations). Additionally, a minor update of ASP specification may lead to a different ASP for the same query plan. These auxiliary details and/or ASP specification update can introduce noise and complexity into the comparison process, making it difficult to accurately determine the distinctiveness of query plans in terms of their underlying operation logic.

As described more fully below, the query tree of each query plan can be transformed into a simplified representation, such as a tree-shape string or a hash value, which represents the shape of the query tree. Such simplified representation captures the logical relationship of query operations, while removing the auxiliary details that do not affect the shape of the query tree. A comparison of these simplified representations can effectively determine whether two query plans are identical or distinct from one another. As a result, this approach allows for more efficient and meaningful comparisons, thereby enhancing the management of the QPS feature.

As described herein, when a new query plan is generated by the query optimizer, the corresponding ASP is created. This ASP is then compared to the stored ASPs for the same query, based on their simplified representations which capture the logical relationship of query operations. If no match is found, indicating that the new ASP is distinct, it will be stored in the ASP storage, provided that the storage has not reached its maximum capacity. If a match is found, the new ASP is discarded as it is a duplicate. On the other hand, if the ASP storage has reached its maximum capacity and no match is found for the new ASP, one of the stored ASPs can be removed to make room for the new ASP. The decision on which ASP to remove can be based on a predefined eviction policy, which could be based on various criteria such as removing the oldest ASP, removing the ASP associated with the worst performance (e.g., longest execution time, largest CPU and/or peak memory consumption, etc.), or other relevant factors.

In an initialization scenario where the improved QPS feature with distinct query plan capture is introduced into an existing DBMS, the system may already have a storage of ASPs that potentially represent duplicate query plans. With the introduction of this new feature, the system can be configured to automatically detect and eliminate these duplicates. This can be achieved by comparing the simplified representations of each ASP, which capture the logical relationship of query operations. Any ASPs that are found to represent duplicate query plans can be removed from the storage. As a result, the ASP storage can be optimized to only retain ASPs representing distinct query plans.

### Example Transformations of Query Plans

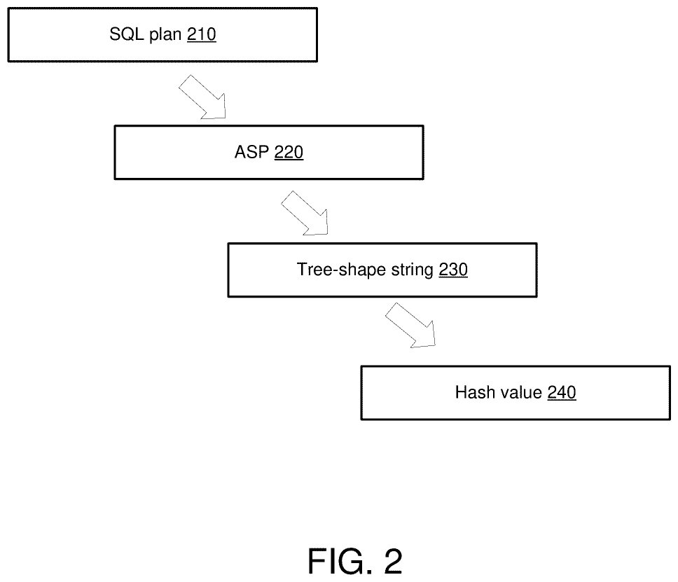

FIG. 2 depicts example transformations of a query plan 210 into simplified representations.

First, the query plan 210, which can be represented by a query tree, is converted into a serialized form known as a query plan object or ASP 220. As described further below, the ASP 220 is a type of software artifact which can be expressed in a structured data exchange format (e.g., JSON, etc.). The ASP 220 can specify the query tree. For example, the ASP 220 can include pairs of attributes and values extracted from the query tree. These pairs, which can be nested within sub-objects, serve to characterize the logical structure and properties of the original query tree representing the query plan 210.

Next, the ASP 220 is converted into a tree-shape string 230. This tree-shape string 230 encapsulates the logical relationships of query operations, while discarding the auxiliary details that do not impact the shape of the query tree. Specifically, the tree-shape string 230 includes the names of the query operators as defined by the query tree. These operator names are arranged in a specific sequence that reflects the sequence of query operations defined by the query tree, thereby preserving the inherent logic of the original query plan 210. By comparing these tree-shape strings 230, a determination can be made whether two query plans are identical or distinct, based on their logical structure and sequence of operations.

Optionally, the tree-shape string 230 can be converted into a hash value 240, for example, by applying a hash function to the tree-shape string 230. The hash value 240 can serve as a unique identifier for the query plan. Thus, whether two query plans are identical or distinct can be determined by comparing their corresponding hash values 240. Comparing hash values 240 can be more efficient than comparing the tree-shape strings 230 because hash values 240 are typically fixed in length (while the tree-shape strings 230 may vary in length) and can represent large amounts of data (e.g., very long tree-shape strings 230) in a more compact form, allowing for quicker comparison operations.

### Example Components of QPS Manager

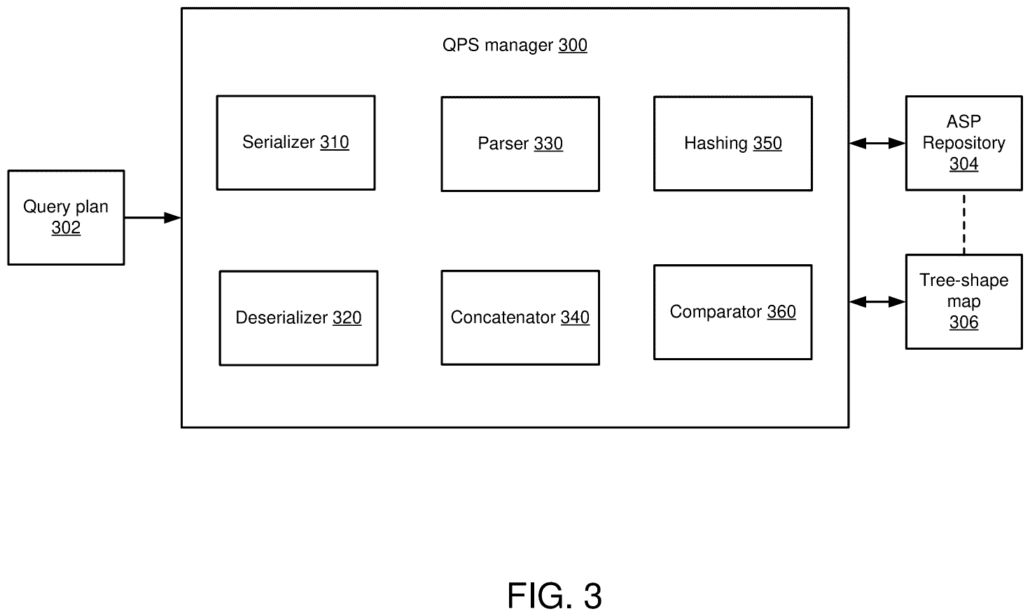

FIG. 3 is a block diagram depicting example components of a QPS manager 300 supporting distinct query plan capture and ASP storage. The QPS manager 300 can replace the QPS manager 162 of FIG. 1. As shown in FIG. 3, the QPS manager 300 can include a serializer 310, a deserializer 320, a parser 330, a concatenator 340, a hashing unit 350, and a comparator.

The serializer 310 is configured to serialize a query plan 302 compiled for a query. The serialization transforms a query tree of the query plan 302 into a data stream, such as an ASP (e.g., the ASP 220). The query tree typically includes multiple nodes (representing operations) and edges that link these nodes (representing the data flow between these operations). The serializer 310 can traverse the query tree in an ordered sequence (e.g., using the depth-first search algorithm, as described below, or the like) to extract all the necessary information for query execution. As described further below, such information includes operators, expressions, data sources, annotations, etc., which are then converted into attribute-value pairs and written into an ASP. Additionally, the hierarchical relationships between nodes, represented by the edges connecting the nodes, are also preserved in the ASP.

The generated ASP can be stored in an ASP repository 304 (similar to the ASP repository 124 of FIG. 1) if it is deemed to be unique (i.e., not already stored in the ASP repository 304). The ASP repository 304 can have a dedicated storage space to store a number of ASPs represent distinct query plans for each query. Additionally, the performance metrics (e.g., the execution time, the CPU consumption, the peak memory usage, etc.) of the corresponding query plan 302 can also be saved in the ASP repository 304.

The deserializer 320 is configured to perform deserialization, a process which convert the serialized data stream or the ASP back into a query tree representing the original query plan. Specifically, the deserializer 320 can read the attribute-value pairs from the ASP and uses this information to reconstruct the nodes and edges of the original query tree. Thus, in the event of a performance regression in a query plan for a query, the QPS manager 300 can retrieve, from the ASP repository 304, a previous ASP serialized from a legacy query plan for the query that has better performance metrics. The deserializer 320 can convert the retrieved ASP back into the query tree of the legacy query plan, thereby retaining the original query performance.

The parser 330 is configured to parse the ASP to extract attribute-value pairs. From the extracted attribute-value pairs, the parser 330 can identify operator names corresponding to the operations represented by the nodes of the query tree. Additionally, the parser 330 can identify hints from the extracted attribute-value pairs. These hints can be associated with any of the operations denoted by the operator names.

The concatenator 340 is configured to concatenate the operator names (and the associated hints, if any) into a tree-shape string (e.g., the tree-shape string 230). Specifically, the concatenator 340 can traverse the query tree in an ordered sequence, using the hierarchical relationships stored in the ASP. Concatenation of the operator names (and the associated hints, if any) can be based on this ordered sequence. The traversal can be performed using algorithms such as the depth-first search algorithm, among others.

In some examples, the concatenator 340 can further insert specific characters or tokens at suitable positions within the tree-shape string. For example, if the parser 330 identifies a hint corresponding to an operation denoted by an operator name, the hint can be appended to the operator name, and a predefined token (e.g., an at sign @, or the like) can be inserted between the operator name and the hint for clear distinction. As another example, the concatenator 340 can group at least two operator names within a pair of parentheses if these operator names correspond to two query operators that share a parent query operator in the query tree. This grouping can be recursive, reflecting the hierarchical relationship of the nodes.

The hashing unit 350 is configured to apply a hash function to the tree-shape string to generate a hash value (e.g., the hash value 240) represented by a fixed-length string of characters. Different hashing algorithms can be used to implement the hash function. In some examples, the hashing unit 350 can implement a hash algorithm configured to minimize collisions so as to ensure the uniqueness of the generated hash values. For example, SHA-256 (part of the SHA-2 family) algorithm can be used to generates a 256-bit hash value for each input string, and due to its large output space, it is extremely unlikely for two different input strings to produce the same hash value.

The comparator 360 is configured to determine if two query plans are identical or distinct. Such comparison can be based on either a string comparison of the tree-shape strings generated by the concatenator 340 or a comparison of the hash values generated by the hashing unit 350. If two tree-shape strings or their hash values are identical, it implies that the corresponding two query plans are identical, and vice versa.

The QPS manager 300 can maintain a tree-shape map 306 along with the ASP repository 304. Each ASP stored in the ASP repository 304 can be mapped to a simplified representation in the tree-shape map 306. For example, the tree-shape map 306 can store unique tree-shape strings generated by the concatenator 340. Each ASP stored in the ASP repository 304 can be mapped to a unique tree-shape string in the tree-shape map 306. Alternatively, the tree-shape map 306 can store the unique hash values generated by the hashing unit 350, in which case the tree-shape map 306 can also be referred to as a hash map. Each ASP stored in the ASP repository 304 can be mapped to a unique hash value stored in the hash map. Thus, to ensure the ASPs stored in the ASP repository 304 represent distinct query plans, the ASP generated for the query plan 302 can be first converted to a simplified representation (e.g., tree-shape string or corresponding hash value), which is then compared to the simplified representations stored in the tree-shape map 306. The generated ASP can be stored in the ASP repository only if no matching is found by the comparison.

### Example Overall Method for Improved Query Plan Stability Management

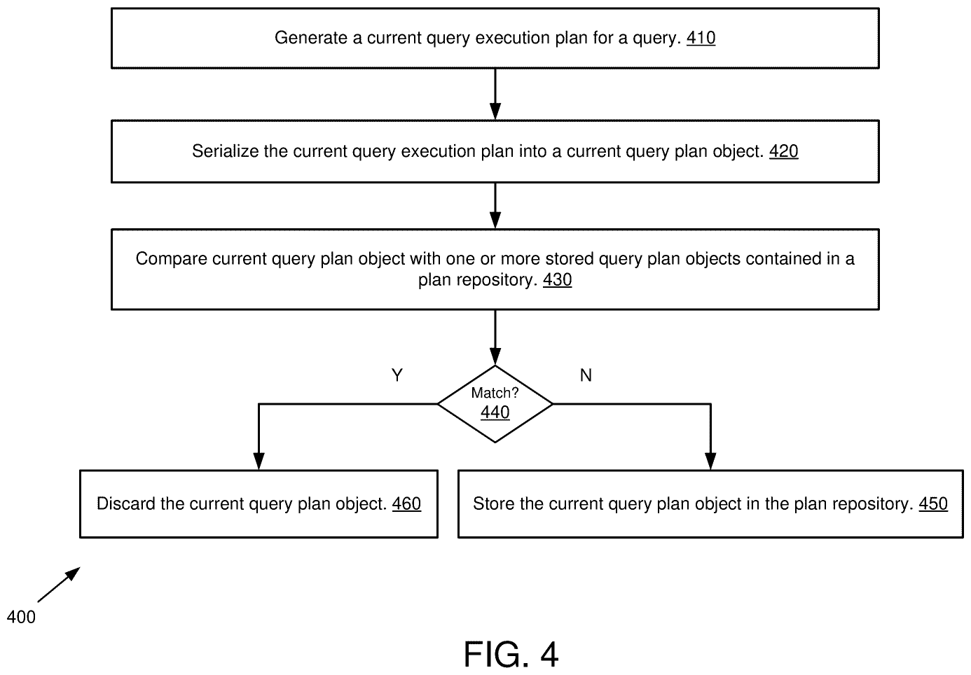

FIG. 4 is a flowchart illustrating an overall method 400 of implementing distinct query plan capture for query plan stability, and can be performed, for example, by the database management system of FIG. 1.

At step 410, the method can generate a current query execution plan for a query. Generating the current query execution plan can be performed, e.g., by the query optimizer 160 of FIG. 1.

At step 420, the method can serialize the current query execution plan into a current query plan object (or current ASP). The current query plan object includes a plurality of attribute-value pairs extracted from a query tree which defines a plurality of query operators of the current query execution plan. Serializing the current query execution plan can be performed, e.g., by the serializer 310 of FIG. 3.

At step 430, the method can compare the current query plan object with one or more stored query plan objects (or stored ASPs) contained in a plan repository (e.g., the ASP repository 124 of FIG. 1). The one or more stored query plan objects were serialized from previous query execution plans generated for the query.

In some examples, the comparison can be performed based on string comparisons. For example, the current query plan object can be converted into a current tree-shape string, and each stored query plan object can also be converted into a corresponding tree-shape string. The comparison of these tree-shape strings can then be used to determine if the current query plan object matches any of the stored query plan objects. In some examples, the comparison can be performed based on value comparisons. For example, the current tree-shape string can be hashed to generate a current hash value, and a tree-shape string for each stored query plan object can also be hashed to generate a corresponding hash value. The comparison of these hash values can then be used to determine if the current query plan object matches any of the stored query plan objects.

At step 440, a condition check can be performed to determine if the current query plan object matches any of the one or more stored query plan objects.

Responsive to finding that no stored query plan object matches the current query plan object, the method can proceed to step 450, where the current query plan object can be stored in the plan repository. For example, if the number of previously stored query plan objects for the query has not reached a predefined capacity limit, the current query plan object can be directly stored in the plan repository. On the other hand, if the plan repository has already reached its maximum capacity for the query, one of the previously stored query plan objects can be removed before storing the current query plan object.

On the other hand, responsive to finding that at least one of the stored query plan objects matches the current query plan object, the method can proceed to step 460, wherein the current query plan object can be discarded. As such, duplicate query plan objects will not be saved in the plan repository, that is, the plan repository stores only distinct query plan objects for the query.

The method 400, and any other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example Query Tree

To further illustrate the distinct query plan capture feature, an example is described herein to illustrate the process of generating a tree-shape string (and the corresponding hash value) from a query plan compiled for a query.

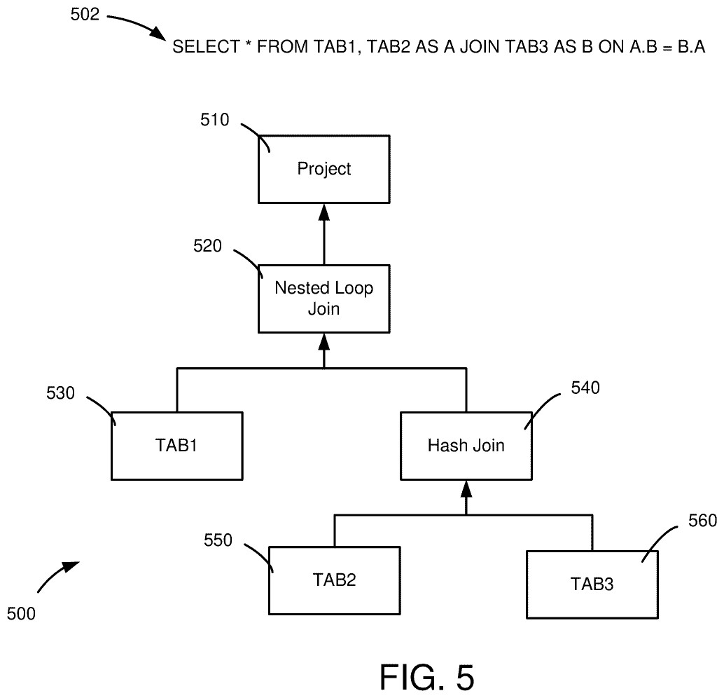

FIG. 5 show an example SQL query 502 expressed as a SELECT statement:
SELECT * FROM TAB1, TAB2 AS A JOIN TAB3 AS B ON A.B=B.A

This SQL query 502 needs to access three data tables tab1, tab2, and tab3, which can have the following table definitions for illustration purposes:
CREATE TABLE TAB1 (A INT, B INT, C INT);
CREATE TABLE TAB2 (A INT, B INT, C INT);
CREATE TABLE TAB3 (A INT, B INT, C INT);

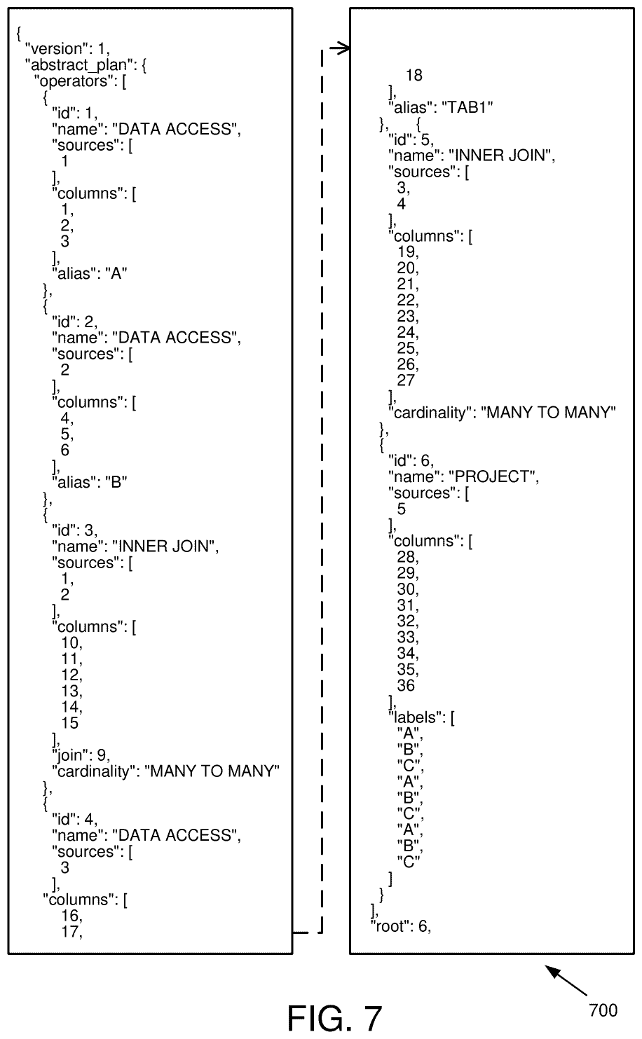

A query optimizer can compile the query 502 to generate a query plan, which can be represented by a query tree 500, as shown in FIG. 5. In this example, the query tree 500 includes a root node 510 (‘Project’) which represents the final output of the query 502, two inner nodes representing table join operations (e.g., one inner node 520 represents a nested loop join operation, and another inner node 540 represents a hash join operation), and three leaf nodes representing table scan operations for data access (e.g., one leaf node 530 represents data access of TAB1, another leaf node 540 represents data access of TAB2, and a third leaf node 560 represents data access of TAB3). The edges (with arrows) between the nodes indicate the flow and dependencies between different operations. They connect nodes to show the order of execution and how data flows through the query plan. For example, the inner node 540 indicates that a hash join operation is used to combine rows from TAB2 (leaf node 550) and TAB3 (leaf node 560) based on a condition, and the inner node 520 indicates that a nested loop join operation is performed to combine rows from TAB1 (leaf node 530) and the result of hash join (inner node 540) based on a condition. Thus, the query tree 500 provides a structured representation of how the SQL query 502 is executed. For simplicity, most auxiliary details of the query plan that do not affect the structure of the query tree 500 are omitted in FIG. 5. These auxiliary details can be captured in the ASP, as described further below with reference to FIGS. 7-10.

### Example Query Tree Traversal Methods

As described above, a query plan can be serialized into an ASP, e.g., by the serializer 310 of FIG. 3. The serialization can be performed by traversing a query tree of the query plan in an ordered sequence to extract all the necessary information needed for the execution of the query plan. The extracted information can be stored in the ASP as a list of attribute-value pairs.

One example method that can be used to traverse the query tree is the depth-first search (DFS) algorithm. There are several variants of the DFS algorithm, each with its own traversing order. These include inorder traversal, preorder traversal, and postorder traversal. In an inorder traversal, the algorithm first visits the left subtree, then the root node, and finally the right subtree. In a preorder traversal, the root node is visited first, followed by the left subtree, and then the right subtree. In a postorder traversal, the algorithm first visits the left subtree, then the right subtree, and finally the root node.

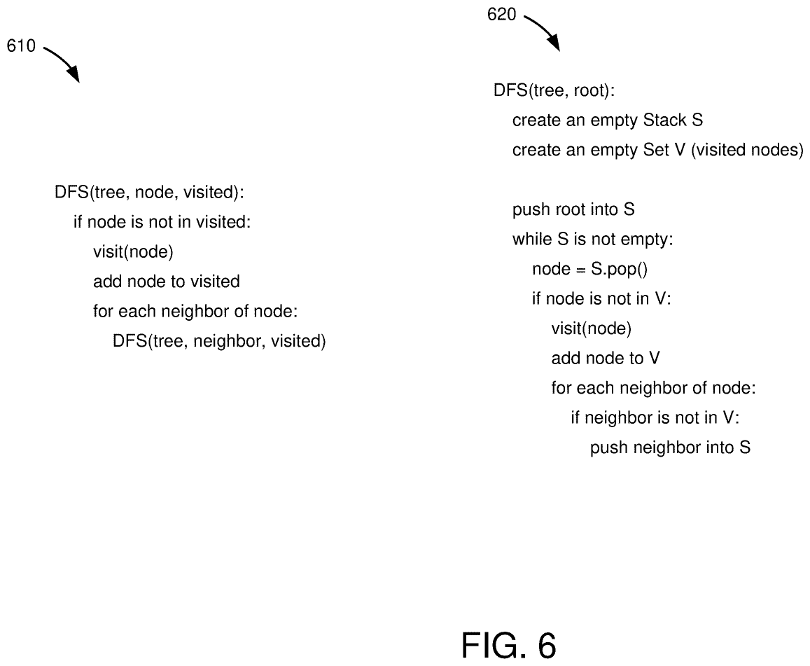

FIG. 6 shows the pseudo-code of implementing the DFS algorithm using a recursive method 610. This recursive method 610 of DFS works by visiting a node, marking it as visited, and then recursively visiting all its unvisited neighbors. It uses the system stack for recursion, which makes it simple but potentially memory-intensive for large query trees. FIG. 6 also shows the pseudo-code of implementing the DFS algorithm using a non-recursive method 620, which uses an explicit stack. This method starts at the root node, pushes it onto the stack, and then enters a loop. In each iteration of the loop, it pops a node from the stack, visits it, adds it to the visited set, and then pushes all its unvisited neighbors onto the stack. The non-recursive method 620 is more space-efficient for large query trees, as it only needs to store the nodes on the current path and their unvisited neighbors. Both methods 610 and 620 ensure that every node is visited once, making them suitable for traversing the query tree.

Although the depth-first search algorithm is described above as an example query tree traversal method, it should be understood that other tree traversal algorithms can also be used, such as the breath-first search algorithm, the boundary traversal algorithm, the diagonal traversal algorithm, etc.

### Example ASP Object

For illustration purpose, FIGS. 7-10 show a query plan object or ASP serialized from a query plan represented by the query tree 500 of FIG. 5. It should be understood that the exact structure and/or format of the ASP can vary depending on software designs so long as the information encapsulated in the ASP can be used to reconstruct the query plan.

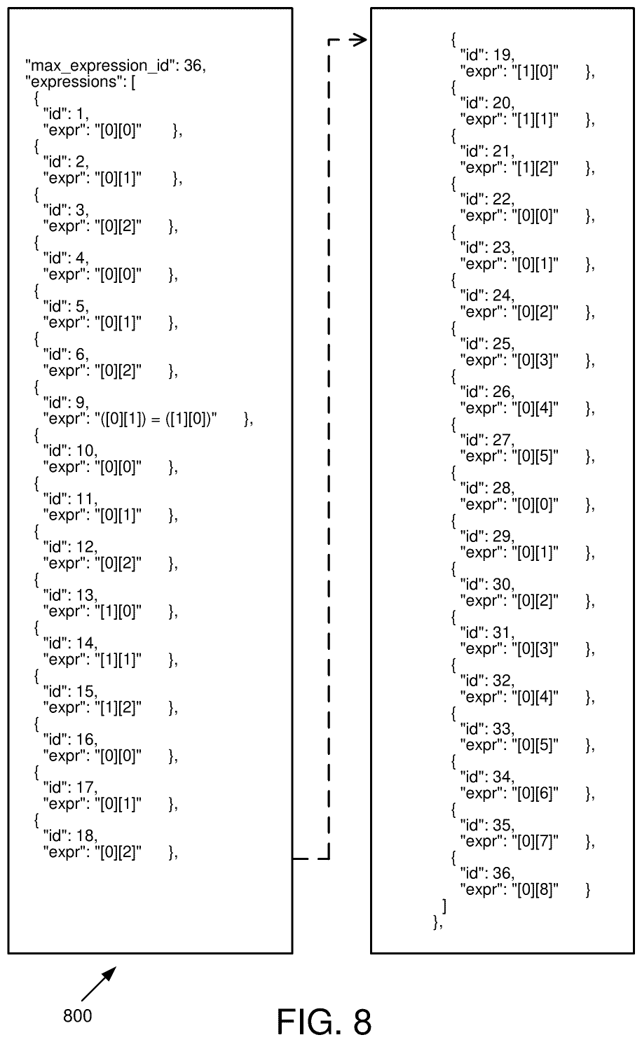

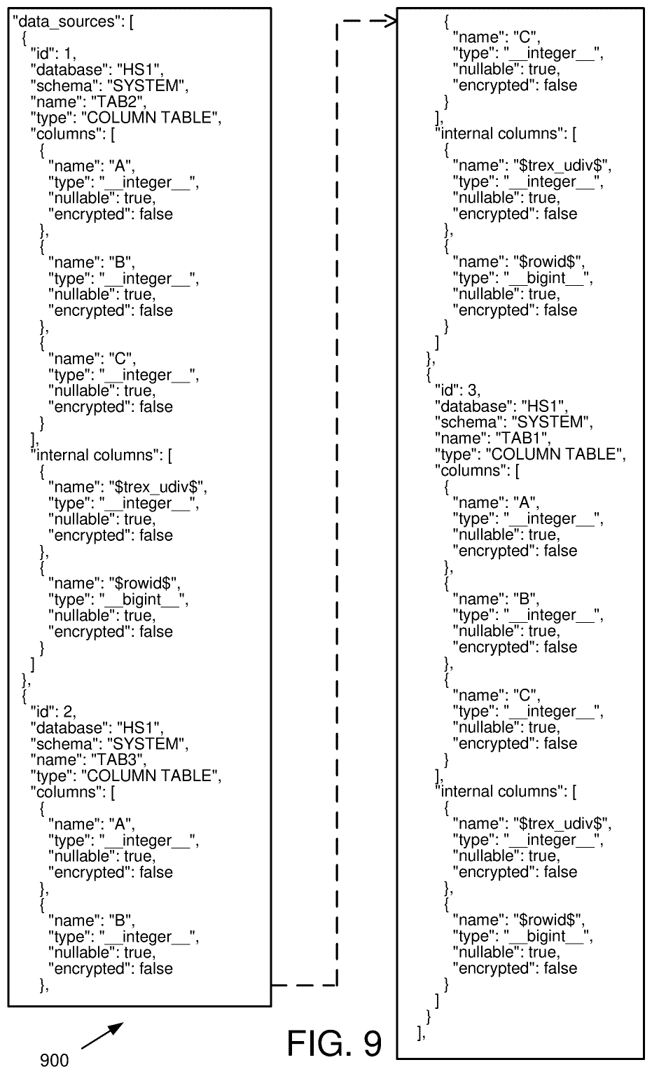

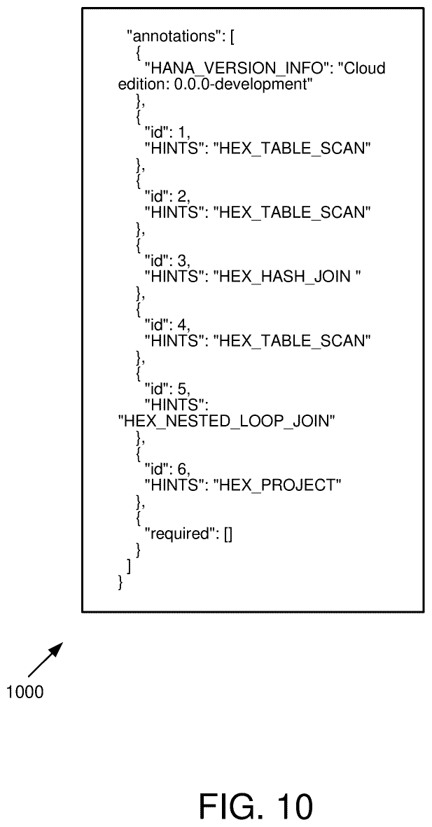

In the depicted example, the ASP is expressed as a JSON object, including a list of attribute-value pairs that are grouped into multiple components or object arrays organized in a nested structure. For example, the ASP includes object arrays such as “operators” 700 (FIG. 7), “expressions” 800 (FIG. 8), “data_sources” 900 (FIG. 9), and “annotations” 1000 (FIG. 10). The object arrays “operators” 700 and “expressions” 800 can be grouped into an “abstract_plan” object.

Each object in the object array “operators” 700 represents an operation in the query plan and includes several attributes. The ‘id’ attribute is a unique identifier for the operator. The ‘name’ attribute indicates the type of operation, such as “DATA ACCESS”, “JOIN”, “ORDER BY”, etc. The ‘sources’ attribute lists the ids of the child operators or data sources, thereby defining the hierarchical relationship of the operations. The ‘columns’ attribute optionally lists the ids of the output column expressions (defined in the object array “expressions” 800). The ‘alias’ attribute, if present, provides an alias for the operator.

The object array “operators” 700 can define the logical relationship of query operations represented by the query tree 500. Specifically, each operator in the object array “operators” 700 corresponds to an operation represented by a node (including access to a data source represented by a leaf node) in the query tree 500. The hierarchical relationship of these operators, which is represented by the edges of the query tree 500, is depicted by the “sources” attribute. The object array “operators” 700 collectively define the logical relationship of query operations in the ASP. The hierarchical relationship depicted by the “sources” mirrors the structure of the query tree, thereby enabling the reconstruction of the query plan from the ASP.

For instance, FIG. 7 shows that the root of the query tree 500 is defined by the “root” attribute, which has a value 6, referencing the root node 510 represented by a first object with an id 6 and operator name “PROJECT.” The ‘sources’ attribute of this first object has a value 5, referencing its child node 520 represented by a second object with an id 5 and operator name ‘INNER JOIN.” The ‘sources’ attribute of this second object has two values [3, 4], referencing its two child nodes 540 and 530, respectively. The child node 540 is represented by a third object with an id 3 and operator name ‘INNER JOIN.” The child node 530 is represented by a fourth object with an id 4 and operator name “DATA ACCESS,” indicating the child node 530 is a leaf node whose operation is scanning a table (e.g., TAB1 in this example). The ‘sources’ attribute of the third object has two values [1, 2], referencing its two child nodes 550 and 560, respectively. The child node 550 is represented by a fifth object with an id 1 and operator name “DATA ACCESS,” indicating the child node 550 is a leaf node for scanning a table (e.g., TAB2 in this example). Similarly, The child node 560 is represented by a sixth object with an id 2 and operator name “DATA ACCESS,” indicating the child node 560 is a also leaf node for scanning a table (e.g., TAB3 in this example). In FIG. 7, the source id of each object representing a leaf node (e.g., id=1, 2, and 3) points to a corresponding data source (with identical id) defined by the object array “data_sources” 900 of FIG. 9.

The object array “expressions” 800 contains the mathematical and logical expressions used in the query plan. Specifically, the “expressions” 800 include string representations of operations or computations that are performed within the nodes of the query tree 500. They are similar to SQL expressions, with the exception of expression variables, which are placeholders used in expressions to refer to specific data sources or columns. Each expression in the object array “expressions” 800 can have a unique identifier (‘id’) and the expression can have the following format:
[<prefix>][<index_of_input_data_source>][<index_of_column_expression>]

The prefix and indices in the brackets can have different meanings. For example, an expression having two bracket numbers can refer to a column of a child node (e.g., [0] [1] can refer to the second column of the first child node). As another example, an expression “SUM ([0] [1])” can represent the sum of the second column from the first child relation or data source. As a further example, an expression “[0] [0]=1 AND [0] [3] LIKE ‘% TEST %’” can represent a filter which filters for rows where the first column is 1 and the fourth column contains the string ‘TEST.’

The object array “data_sources” 900 encapsulates information about the input data sources for the query plan. These could be tables, views, or any other data sources that can provide data in a tabular format. Each data source can be defined by a set of attributes like ‘id’ (a unique identifier for the data source), ‘database’ (the database where the data source resides), ‘schema’ (the schema under which the data source is organized), ‘name’ (the name of the data source), ‘type’ (the type of the data source, such as column table or view), and ‘columns’ (the columns present in the data source, including column names, data types, etc.).

The object array “annotations” 1000 provides optional information that the query optimizer can utilize when searching for the optimal query execution plan. The scope of the annotations can vary. For example, some annotations can be applied to the whole query execution plan (e.g., if the annotations are not specified for particular nodes), and some annotation can be applied to specific nodes (e.g., by pairing the annotations to those nodes). Example annotations can be hints or hint strings. For instance, in the example depicted in FIG. 10, the annotation with ‘id’ 3 (referencing the object with the operator name ‘INNER JOIN” included in the object array “operators” 700, representing the node 540 of FIG. 5) has a hint “HEX HASH_JOIN” which could instruct the query optimizer to use a hash join operation when joining data from its data sources (e.g., TAB2 and TAB3 in this example).

Thus, the ASP is a comprehensive representation of a query plan, capturing not just the operations to be performed (via the “operators” array) but also a vast amount of auxiliary information including the expressions involved, the data sources to be used, optimization hints, and other relevant metadata (e.g., versioning information, etc.) all organized in a nested structure that mirrors the hierarchy of the original query tree.

### Example Methods for Generating a Tree-Shape String and Hashing

As described above, an ASP serialized from a query plan can be further converted into a tree-shape string, which captures the logical relationships of query operations, while discarding auxiliary details that do not impact the shape of the query tree representing the query plan. Such conversion can be performed by first parsing the ASP (e.g., by the parser 330 of FIG. 3) to identify a plurality of operator names in corresponding attributes of the plurality of query operators (e.g., the ‘name’ attributes in the object array “operators” 700). These operator names correspond to the operations performed at respective nodes of the query tree. Then, these operator names can be concatenated based on an ordered sequence (e.g., by the concatenator 340 of FIG. 3). The ordered sequence can represent a path for traversing the query tree using a predefined tree traversal method, such as the DFS algorithm or the like, as described above.

In some examples, when constructing the tree-shape string, if at least two operator names correspond to query operators that share a common parent query operator in the query tree, the at least two operator names can be grouped within a pare of parentheses. For instance, if operator names ‘A’ and ‘B’ share a parent query operator, they would be represented as (A, B) in the tree-shape string. This helps in preserving the logical relationships between different query operations in the query plan.

In some examples, parsing the ASP can also identify a hint string associated with a selected query operator. This hint string provides additional information or instructions that can guide the query optimizer in choosing an optimal query plan. In the conversion process, this hint string can be appended to the operator name of the selected query operator, and a predefined token (e.g., the at sign ‘@’ or the like) can be inserted therebetween to separate the operator name from the hint string. For example, if the operator name is ‘C’ and the associated hint string is ‘HEX_TABLE_SCAN’, the resulting representation in the tree-shape string would be ‘C@HEX_TABLE_SCAN’. This allows the optimizer to consider these hints when constructing the execution plan.

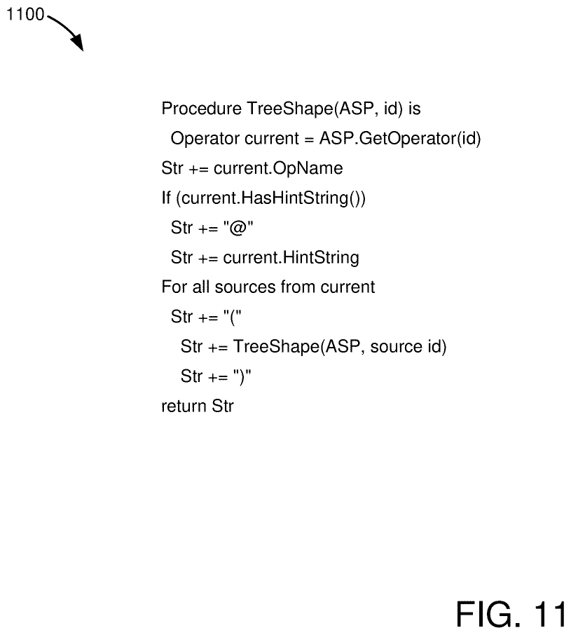

FIG. 11 shows the pseudo-code of an example method 1100 for transforming an ASP into a tree-shape string. The method 1100 utilizes a recursive procedure ‘TreeShape’ which takes two parameters ‘ASP’ (the source ASP object) and ‘id’ (the identifier of the current query operator). The method 1100 retrieves the current operator from the ASP, appends its name to a string, and if a hint string is present, it appends it as well. The procedure then iterates over all child nodes of the current operator, recursively calling ‘TreeShape’ for each child and appending the result to the string within parentheses. The order and grouping of these operator names in the tree-shape string reflect the structure and logical relationships of the query operators in the query tree. Thus, this process effectively captures the structure and operations of the query tree in a string format, including any associated hint strings, thereby providing a compact representation of the query plan.

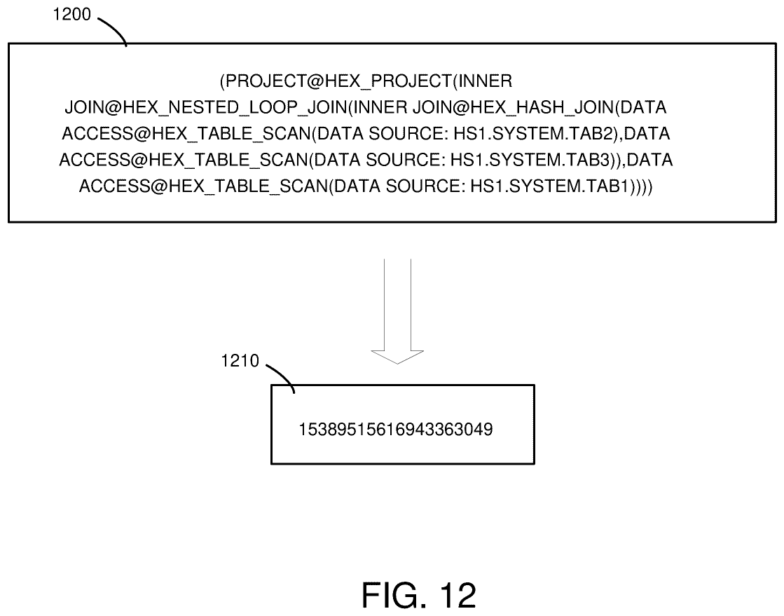

As an example, FIG. 12 shows an example tree-shape string 1200 converted from the ASP depicted in FIGS. 7-10. As shown, the operator names specified in the ASP are concatenated in an ordered sequence and the hierarchical relationship of those operators are preserved in the tree-shape string, represented by the nested parentheses. Additionally, the hints associated with respective operators are appended to the corresponding operator names in the tree-shape string, separated by a predefined token ‘@’. Thus, the tree-shape string 1200 effectively captures the structure, operations, and optimization hints of the query plan in a compact and efficient representation.

FIG. 12 also shows a hash value 1210 converted from the tree-shape string 1200, e.g., by applying a hash function implemented by the hashing unit 350 of FIG. 3. As described above, either the tree-shape string 1200 or the hash value 1210, or both, can be used in comparison to determine uniqueness of query plans.

### Example Advantages

The disclosed technologies offer several technical advantages in the realm of query optimization and performance stability.

First, the improved QPS technologies described herein allows more efficient management of ASPs. Specifically, the disclosed technologies ensures that only ASPs representing distinct query plans are captured and stored in an ASP repository. By avoiding the storage of duplicate ASPs, the system can optimize storage usage, thereby improving overall efficiency of the DBMS, particularly when dealing with a large number of complex queries.

Moreover, the transformation of ASPs into tree-shape strings encapsulates the logical structure and operations of query plans in a compact and efficient format. This condensed representation not only reduces storage requirements but also eases the task of distinguishing and recognizing distinct query plans. The incorporation of hash values amplifies these benefits, further optimizing storage use and improving the efficiency of the comparison process.

### Example Computing Systems

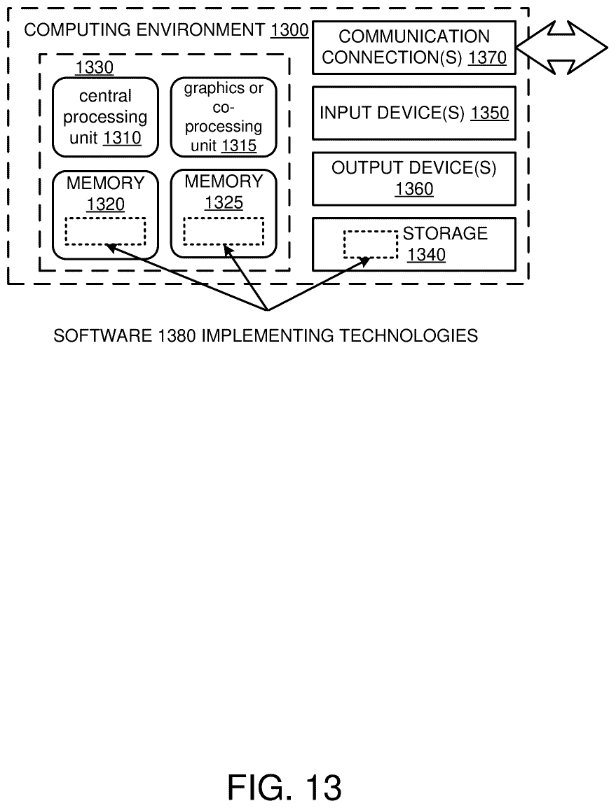

FIG. 13 depicts an example of a suitable computing system 1300 in which the described innovations can be implemented. The computing system 1300 is not intended to suggest any limitation as to scope of use or functionality of the present disclosure, as the innovations can be implemented in diverse computing systems.

With reference to FIG. 13, the computing system 1300 includes one or more processing units 1310, 1315 and memory 1320, 1325. In FIG. 13, this basic configuration 1330 is included within a dashed line. The processing units 1310, 1315 can execute computer-executable instructions, such as for implementing the features described in the examples herein (e.g., the method 400). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 13 shows a central processing unit 1310 as well as a graphics processing unit or co-processing unit 1315. The tangible memory 1320, 1325 can be volatile memory (e.g., registers, cache, RAM), non-volatile memory (e.g., ROM, EEPROM, flash memory, etc.), or some combination of the two, accessible by the processing unit(s) 1310, 1315. The memory 1320, 1325 can store software 1380 implementing one or more innovations described herein, in the form of computer-executable instructions suitable for execution by the processing unit(s) 1310, 1315.

A computing system 1300 can have additional features. For example, the computing system 1300 can include storage 1340, one or more input devices 1350, one or more output devices 1360, and one or more communication connections 1370, including input devices, output devices, and communication connections for interacting with a user. An interconnection mechanism (not shown) such as a bus, controller, or network can interconnect the components of the computing system 1300. Typically, operating system software (not shown) can provide an operating environment for other software executing in the computing system 1300, and coordinate activities of the components of the computing system 1300.

The tangible storage 1340 can be removable or non-removable, and includes magnetic disks, magnetic tapes or cassettes, CD-ROMs, DVDs, or any other medium which can be used to store information in a non-transitory way and which can be accessed within the computing system 1300. The storage 1340 can store instructions for the software implementing one or more innovations described herein.

The input device(s) 1350 can be an input device such as a keyboard, mouse, pen, or trackball, a voice input device, a scanning device, touch device (e.g., touchpad, display, or the like) or another device that provides input to the computing system 1300. The output device(s) 1360 can be a display, printer, speaker, CD-writer, or another device that provides output from the computing system 1300.

The communication connection(s) 1370 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

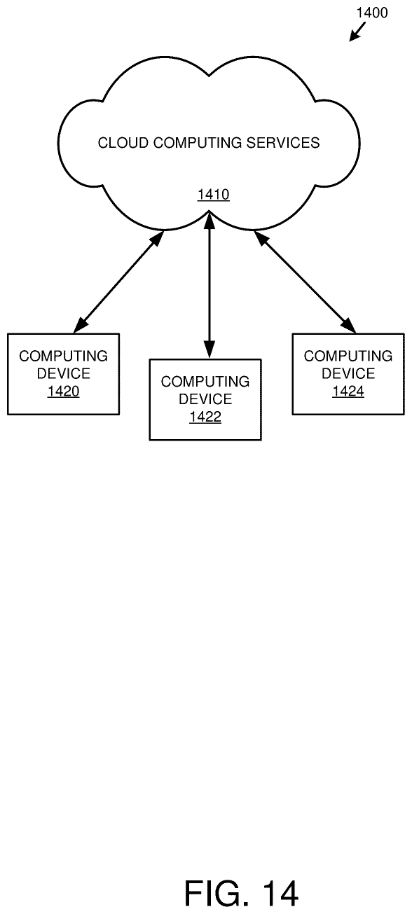

FIG. 14 depicts an example cloud computing environment 1400 in which the described technologies can be implemented, including, e.g., the system 100 and other systems herein. The cloud computing environment 1400 can include cloud computing services 1410. The cloud computing services 1410 can comprise various types of cloud computing resources, such as computer servers, data storage repositories, networking resources, etc. The cloud computing services 1410 can be centrally located (e.g., provided by a data center of a business or organization) or distributed (e.g., provided by various computing resources located at different locations, such as different data centers and/or located in different cities or countries).

The cloud computing services 1410 can be utilized by various types of computing devices (e.g., client computing devices), such as computing devices 1420, 1422, and 1424.

For example, the computing devices (e.g., 1420, 1422, and 1424) can be computers (e.g., desktop or laptop computers), mobile devices (e.g., tablet computers or smart phones), or other types of computing devices. For example, the computing devices (e.g., 1420, 1422, and 1424) can utilize the cloud computing services 1410 to perform computing operations (e.g., data processing, data storage, and the like).

In practice, cloud-based, on-premises-based, or hybrid scenarios can be supported.

### Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example Clauses

Any of the following example clauses can be implemented.
Clause 1. A computer-implemented method comprising: generating a current query execution plan for a query; serializing the current query execution plan into a current query plan object, wherein the current query plan object specifies a query tree which defines a plurality of query operators of the current query execution plan; comparing the current query plan object with one or more stored query plan objects contained in a plan repository, wherein the one or more stored query plan objects were serialized from previous query execution plans generated for the query; responsive to finding that no stored query plan object matches the current query plan object, storing the current query plan object in the plan repository.
Clause 2. The method of clause 1, further comprising converting the current query plan object into a current tree-shape string, wherein the current tree-shape string comprises a plurality of operator names corresponding to the plurality of query operators defined by the query tree.
Clause 3. The method of clause 2, wherein converting the current query plan object comprises parsing the current query plan object, wherein parsing the current query plan object identifies the plurality of operator names in corresponding attributes of the plurality of query operators.
Clause 4. The method of clause 3, wherein converting the current query plan object further comprises traversing the query tree in an ordered sequence, and concatenating the plurality of operator names based on the ordered sequence.
Clause 5. The method of clause 4, wherein converting the current query plan object further comprises grouping at least two of the operator names within a pair of parentheses if the two operator names correspond to two query operators that share a parent query operator in the query tree.
Clause 6. The method of any one of clauses 3-5, wherein parsing the current query plan object further identifies a hint string associated with a selected query operator, wherein converting the current query plan object further comprises appending the hint string to an operator name of the selected query operator.
Clause 7. The method of any one of clauses 2-6, wherein comparing the current query plan object with a stored query plan object comprises comparing the current tree-shape string with a tree-shape string converted from the stored query plan object.
Clause 8. The method of any one of clauses 2-7, further comprising generating a current hash value based on the current tree-shape string, wherein the one or more stored query plan objects are converted to respective tree-shape strings, based on which one or more hash values are generated and stored in a hash map.
Clause 9. The method of clause 8, wherein comparing the current query plan object with a stored query plan object comprises comparing the current hash value with a hash value stored in the hash map that corresponds to the stored query plan object.
Clause 10. The method of any one of clauses 1-9, wherein the plan repository has a predefined size, wherein responsive to detecting that a count of the stored query plan objects reaches the predefined size, removing one of the stored query plan objects from the plan repository before storing the current query plan object in the plan repository.
Clause 11. A computing system, comprising: memory; one or more hardware processors coupled to the memory; and one or more computer readable storage media storing instructions that, when loaded into the memory, cause the one or more hardware processors to perform operations comprising: generating a current query execution plan for a query; serializing the current query execution plan into a current query plan object, wherein the current query plan object specifies a query tree which defines a plurality of query operators of the current query execution plan; comparing the current query plan object with one or more stored query plan objects contained in a plan repository, wherein the one or more stored query plan objects were serialized from previous query execution plans generated for the query; responsive to finding that no stored query plan object matches the current query plan object, storing the current query plan object in the plan repository.
Clause 12. The system of clause 11, wherein the operations further comprise converting the current query plan object into a current tree-shape string, wherein the current tree-shape string comprises a plurality of operator names corresponding to the plurality of query operators defined by the query tree.
Clause 13. The system of clause 12, wherein converting the current query plan object comprises parsing the current query plan object, wherein parsing the current query plan object identifies the plurality of operator names in corresponding attributes of the plurality of query operators.
Clause 14. The system of clause 13, wherein converting the current query plan object further comprises traversing the query tree in an ordered sequence, and concatenating the plurality of operator names based on the ordered sequence.
Clause 15. The system of clause 14, wherein converting the current query plan object further comprises grouping at least two of the operator names within a pair of parentheses if the two operator names correspond to two query operators that share a parent query operator in the query tree.
Clause 16. The system of any one of clauses 13-15, wherein parsing the current query plan object further identifies a hint string associated with a selected query operator, wherein converting the current query plan object further comprises appending the hint string to an operator name of the selected query operator.
Clause 17. The system of any one of clauses 12-16, wherein comparing the current query plan object with a stored query plan object comprises comparing the current tree-shape string with a tree-shape string converted from the stored query plan object.
Clause 18. The system of any one of clauses 12-17, wherein the operations further comprise generating a current hash value based on the current tree-shape string, wherein the one or more stored query plan objects are converted to respective tree-shape strings, based on which one or more hash values are generated and stored in a hash map.
Clause 19. The system of clause 18, wherein comparing the current query plan object with a stored query plan object comprises comparing the current hash value with a hash value stored in the hash map that corresponds to the stored query plan object.
Clause 20. One or more non-transitory computer-readable media having encoded thereon computer-executable instructions causing one or more processors to perform a method comprising: generating a current query execution plan for a query; serializing the current query execution plan into a current query plan object, wherein the current query plan object specifies a query tree which defines a plurality of query operators of the current query execution plan; comparing the current query plan object with one or more stored query plan objects contained in a plan repository, wherein the one or more stored query plan objects were serialized from previous query execution plans generated for the query; responsive to finding that no stored query plan object matches the current query plan object, storing the current query plan object in the plan repository.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
generating a current query execution plan for a query;
serializing the current query execution plan into a current query plan object, wherein the current query plan object specifies a query tree which defines a plurality of query operators of the current query execution plan;
comparing the current query plan object with one or more stored query plan objects contained in a plan repository, wherein the one or more stored query plan objects were serialized from previous query execution plans generated for the query;
responsive to finding that no stored query plan object matches the current query plan object, storing the current query plan object in the plan repository.

2. The method of claim 1, further comprising converting the current query plan object into a current tree-shape string, wherein the current tree-shape string comprises a plurality of operator names corresponding to the plurality of query operators defined by the query tree.

3. The method of claim 2, wherein converting the current query plan object comprises parsing the current query plan object, wherein parsing the current query plan object identifies the plurality of operator names in corresponding attributes of the plurality of query operators.

4. The method of claim 3, wherein converting the current query plan object further comprises traversing the query tree in an ordered sequence, and concatenating the plurality of operator names based on the ordered sequence.

5. The method of claim 4, wherein converting the current query plan object further comprises grouping at least two of the operator names within a pair of parentheses if the two operator names correspond to two query operators that share a parent query operator in the query tree.

6. The method of claim 3, wherein parsing the current query plan object further identifies a hint string associated with a selected query operator, wherein converting the current query plan object further comprises appending the hint string to an operator name of the selected query operator.

7. The method of claim 2, wherein comparing the current query plan object with a stored query plan object comprises comparing the current tree-shape string with a tree-shape string converted from the stored query plan object.

8. The method of claim 2, further comprising generating a current hash value based on the current tree-shape string, wherein the one or more stored query plan objects are converted to respective tree-shape strings, based on which one or more hash values are generated and stored in a hash map.

9. The method of claim 8, wherein comparing the current query plan object with a stored query plan object comprises comparing the current hash value with a hash value stored in the hash map that corresponds to the stored query plan object.

10. The method of claim 1, wherein the plan repository has a predefined size, wherein responsive to detecting that a count of the stored query plan objects reaches the predefined size, removing one of the stored query plan objects from the plan repository before storing the current query plan object in the plan repository.

11. A computing system, comprising:
memory;
one or more hardware processors coupled to the memory; and
one or more computer readable storage media storing instructions that, when loaded into the memory, cause the one or more hardware processors to perform operations comprising:
generating a current query execution plan for a query;
serializing the current query execution plan into a current query plan object, wherein the current query plan object specifies a query tree which defines a plurality of query operators of the current query execution plan;
comparing the current query plan object with one or more stored query plan objects contained in a plan repository, wherein the one or more stored query plan objects were serialized from previous query execution plans generated for the query;
responsive to finding that no stored query plan object matches the current query plan object, storing the current query plan object in the plan repository.

12. The system of claim 11, wherein the operations further comprise converting the current query plan object into a current tree-shape string, wherein the current tree-shape string comprises a plurality of operator names corresponding to the plurality of query operators defined by the query tree.

13. The system of claim 12, wherein converting the current query plan object comprises parsing the current query plan object, wherein parsing the current query plan object identifies the plurality of operator names in corresponding attributes of the plurality of query operators.

14. The system of claim 13, wherein converting the current query plan object further comprises traversing the query tree in an ordered sequence, and concatenating the plurality of operator names based on the ordered sequence.

15. The system of claim 14, wherein converting the current query plan object further comprises grouping at least two of the operator names within a pair of parentheses if the two operator names correspond to two query operators that share a parent query operator in the query tree.

16. The system of claim 13, wherein parsing the current query plan object further identifies a hint string associated with a selected query operator, wherein converting the current query plan object further comprises appending the hint string to an operator name of the selected query operator.

17. The system of claim 12, wherein comparing the current query plan object with a stored query plan object comprises comparing the current tree-shape string with a tree-shape string converted from the stored query plan object.

18. The system of claim 12, wherein the operations further comprise generating a current hash value based on the current tree-shape string, wherein the one or more stored query plan objects are converted to respective tree-shape strings, based on which one or more hash values are generated and stored in a hash map.

19. The system of claim 18, wherein comparing the current query plan object with a stored query plan object comprises comparing the current hash value with a hash value stored in the hash map that corresponds to the stored query plan object.

20. One or more non-transitory computer-readable media having encoded thereon computer-executable instructions causing one or more processors to perform a method comprising:
generating a current query execution plan for a query;
serializing the current query execution plan into a current query plan object, wherein the current query plan object specifies a query tree which defines a plurality of query operators of the current query execution plan;
comparing the current query plan object with one or more stored query plan objects contained in a plan repository, wherein the one or more stored query plan objects were serialized from previous query execution plans generated for the query;
responsive to finding that no stored query plan object matches the current query plan object, storing the current query plan object in the plan repository.
